(19) United States
(12) Patent Application Publication
(10) Pub. No.: US 2010/0029514 A1
(43) Pub. Date: Feb. 4, 2010

(54) NAPHTHENIC ACID SOLIDS DISSOLVER COMPOSITIONS AND METHODS RELATED THERETO

(76) Inventors: SANDRA L. BERRY, TOMBALL, TX (US); HAROLD L. BECKER, TOMBALL, TX (US); JOEL L. BOLES, SPRING, TX (US); FRANCES DE BENEDICTIS, SPRING, TX (US); DORA GALVAN, HOUSTON, TX (US)

Correspondence Address: HOWREY LLP, C/O IP DOCKETING DEPARTMENT, 2941 FAIRVIEW PARK DRIVE , Suite 200, FALLS CHURCH, VA, 22042, US

(21) Appl. No.: 12/184,277

(22) Filed: Aug. 1, 2008

(51) Int. Cl. C09K 8/52

(52) U.S. Cl. 507/90

(57) ABSTRACT

Methods and compositions are provided for dissolving naphthenic acid solids from oilfield systems. The composition includes glacial acetic acid and a solvent that is soluble in the glacial acetic acid or a solvent in which the glacial acetic acid is soluble.

### BACKGROUND OF THE INVENTION

1. Field of the Invention

The invention relates to methods and compositions capable of dissolving solids. In particular, the present invention particularly relates to applications in which naphthenic acid solids are present.

2. Description of the Related Art

Crude oil is a complex material that contains thousands of types of components. Many of the components are beneficial, while others are not. One such type of component that is not particularly beneficial is naphthenic acid and its salts, naphthenate. Produced oils from some formations have naphthenic acid components that precipitate in the wellbore or the surface equipment as the produced oil begins to cool. These naphthenic acid components, which can contain calcium and magnesium, precipitate as hardened scale-like materials that can plug the perforations, tubulars, and surface equipment as the oil is being produced. Deposition of the naphthenic acid components can also slow oil production rates, increase cation content of crude oil, and various other problems.

Attempts have been made to try to either prevent formation of the naphthenic acid components or dissolve the naphthenic acid components after they have formed. Attempts to prevent formation of the naphthenic acid components include injecting inhibitors in the crude oil. Attempts to dissolve the naphthenic acid components include contacting the naphthenic acid components with various types of acids. Many of the compounds used to either prevent formation or dissolve the naphthenic acid components caused problems, such as contaminations issues for the produced oil, or they were not very effective. Many of the prior art compositions used to rid systems of the naphthenic acid components were not very environmentally friendly, which limits the applications in which they can be used. Furthermore, some of the prior art compositions were not compatible with the oilfield systems and caused problems, such as corrosion of the equipment.

A need exists for compositions and methods of removing naphthenic acid components from systems. It would be advantageous if the compositions and methods were readily available, compatible with the oilfield system equipment, effective, and environmentally friendly.

### SUMMARY OF THE INVENTION

In view of the foregoing, methods and compositions useful for dissolving solids comprising naphthenic acid solids in oilfield production equipment are provided as embodiments of the present invention. Removal of the dissolved solids allows users to resume normal operations and can increase the quality of the produced oil. A method of dissolving naphthenic acid solids in equipment is provided as an embodiment of the present invention. In this embodiment, naphthenic acid solids are contacted with a treatment fluid. The treatment fluid includes glacial acetic acid and a solvent in which the glacial acetic acid is soluble or a solvent that is soluble in the glacial acetic acid. The treatment fluid dissolves at least a portion of the naphthenic acid solids to reduce the amount of solids in the system.

A method of treating equipment is also provided as an embodiment of the present invention. In this embodiment, a treatment fluid is introduced into the equipment. The treatment fluid includes glacial acetic acid and a solvent in which the glacial acetic acid is soluble or a solvent that is soluble in the glacial acetic acid. The treatment fluid is capable of dissolving at least a portion of a naphthenic acid solid contained within the equipment.

As another embodiment of the present invention, a naphthenic acid solids dissolver composition is provided. The composition includes glacial acetic acid and a solvent in which the glacial acetic acid is soluble or a solvent that is soluble in the glacial acetic acid. The composition can be used to dissolve naphthenic solids located in various types of oilfield equipment.

### BRIEF DESCRIPTION OF THE DRAWINGS

FIG. 1 is a photograph of a sample of naphthenic scale used for the example section of this specification in which the sample was subjected to the methods and compositions made in accordance with embodiments of the present invention.

While the invention is susceptible to various modifications and alternative forms, specific embodiments have been shown by way of example in the drawings and will be described in detail herein. However, it should be understood that the invention is not intended to be limited to the particular forms disclosed. Rather, the intention is to cover all modifications, equivalents and alternatives falling within the spirit and scope of the invention as defined by the appended claims.

### DESCRIPTION OF ILLUSTRATIVE EMBODIMENTS

Illustrative embodiments of the invention are described below as they might be employed in the operation and in the treatment of oilfield applications. In the interest of clarity, not all features of an actual implementation are described in this specification. It will of course be appreciated that in the development of any such actual embodiment, numerous implementation-specific decisions must be made to achieve the developers' specific goals, which will vary from one implementation to another. Moreover, it will be appreciated that such a development effort might be complex and time-consuming, but would nevertheless be a routine undertaking for those of ordinary skill in the art having the benefit of this disclosure. Further aspects and advantages of the various embodiments of the invention will become apparent from consideration of the following description.

While compositions and methods are described in terms of “comprising” various components or steps (interpreted as meaning “including, but not limited to”), the compositions and methods can also “consist essentially of” or “consist of” the various components and steps, such terminology should be interpreted as defining essentially closed-member groups.

As used herein, the term “naphthenic acid” is used to generally describe naphthenic acid and its salts, naphthenates, unless otherwise indicated.

In view of the foregoing, methods and compositions useful for dissolving solids comprising naphthenic acid solids in oilfield production equipment are provided as embodiments of the present invention. A method of dissolving naphthenic acid solids in equipment is provided as an embodiment of the present invention. In this embodiment, naphthenic acid solids are contacted with a treatment fluid. The treatment fluid includes glacial acetic acid and a solvent in which the glacial acetic acid is soluble or a solvent that is soluble in the glacial acetic acid. As will be understood by those of skill in the art, a goal is to achieve a single phase in which the glacial acetic acid and the solvent do not separate. It is irrelevant whether the glacial acetic acid is soluble in the solvent or if the solvent is soluble in the glacial acetic acid. Both of these embodiments are to be considered within the scope of the present invention. The treatment fluid dissolves at least a portion of the naphthenic acid solids to reduce the amount of solids in the system.

A method of treating equipment is also provided as an embodiment of the present invention. In this embodiment, a treatment fluid is introduced into the equipment. The treatment fluid includes glacial acetic acid and a solvent in which the glacial acetic acid is soluble or a solvent that is soluble in the glacial acetic acid. In an aspect, the glacial acetic acid is soluble in the solvent. In another aspect, the solvent is soluble in the glacial acetic acid. In yet another aspect, the glacial acetic acid and the solvent are mutually soluble. The treatment fluid is capable of dissolving at least a portion of a naphthenic acid solid contained within the equipment.

As another embodiment of the present invention, a treatment fluid, which can be referred to as a naphthenic acid solids dissolver composition, is provided. The composition includes glacial acetic acid and a solvent in which the glacial acetic acid is soluble or a solvent that is soluble in the glacial acetic acid.

The amount of the components contained within the treatment fluid can vary. For example, the glacial acetic acid can be present in a range of about 25 wt. % to about 75 wt. % and the solvent is present in a range of about 25 wt. % to about 75 wt. %. Other suitable amounts of the components of the treatment fluid will be apparent to those of skill in the art and are to be considered within the scope of the present invention.

Various types of solvents can be used in embodiments of the present invention. In an aspect, any organic solvent in which the glacial acetic acid is soluble or that is soluble in the glacial acetic acid can be used. In an aspect, the solvent can be an aromatic solvent, a terpene-based solvent, or combinations thereof. In an aspect, the solvent comprises xylene, an ethyl lactate/methyl ester solvent, hexane, heptane, naphtha, kerosene, benzene, toluene, styrene, tetrahydroanaphthalene, decahydroanaphthalene, carbon tetrachloride, acetone, carbon disulfide, n-pentane, a terpene-based solvent, or combinations thereof. A suitable type of terpene-based solvent is commercially available from BJ Services Company as Paravan-25. Another suitable type of terpene-based solvent is d-limonene. As an advantage, many of these solvents are readily available and cost effective. Other suitable types of solvents will be apparent to those of skill in the art and are to be considered within the scope of the present invention.

Ethyl lactate/methyl ester solvent is a particularly suitable choice for the solvent in environmentally sensitive applications. The ethyl lactate/methyl ester solvent is biodegradable, which makes it an environmentally friendly solvent. When the ethyl lactate/methyl ester solvent is used, the amount of each component can vary. For example, the ethyl lactate can be present in a range of about 40 wt. % to about 60 wt. % and the methyl ester can be present in a range of about 40 wt. % to about 60 wt. %. In an aspect, the ethyl lactate/methyl ester solvent contains 50 wt. % ethyl lactate and 50 wt. % methyl ester solvent. Various amounts of each component of the ethyl lactate/methyl ester solvent will be apparent to those of skill in the art and are to be considered within the scope of the present invention.

In some applications, water can be present in the system, such as when the composition of the present invention is used after a water-based fluid has been used in the system. In an aspect, the treatment fluids can also include water.

Naphthenic acid solids cause problems in oilfield applications. Removal or substantial reduction of the solids allows operators to return to normal operations. The methods and compositions of the present invention are very effective at dissolving the naphthenic acid solids and allowing operators to return back to normal operations within a relatively short period of time. In many applications, the solids are dissolved in a time period of less than about twenty-one hours. In some application, the solids are dissolved in less than about five hours; alternatively, in less than about three hours; alternatively, in less than about two hours; or alternatively, in less than about one hour.

Besides working efficiently, the methods and compositions described herein are useful in reducing or dissolving naphthenic acid solids or scale that develop in various types of equipment in the oilfield industry. The scale forms when components, such as calcium and magnesium at a minimum, begin to cool down, harden, and precipitate into the oil. It is believed that naphthenic acid solids can include magnesium, calcium, sodium, carbonate, bicarbonate, chloride, sulfate, strontium, and various other compounds. The naphthenic acid solids can be present throughout the system.

The methods and compositions described herein can be used in various types of equipment used within oilfield applications. For example, the methods and compositions can be used in equipment such as tubing, pipelines, downhole tubulars, surface equipment, perforations, formation lines or pipes, flow lines or pipes, or combinations thereof. The types of surface equipment in which the methods and compositions of the present invention can be used can include tanks, pumps, lines, pipelines, flow lines, and combinations thereof. Other types of applications and equipment in which the compositions and methods described herein can be used will be apparent to those of skill in the art and are to be considered within the scope of the present invention.

### EXAMPLES

The following examples are included to demonstrate the use of compositions in accordance with embodiments of the present invention. It should be appreciated by those of skill in the art that the techniques disclosed in the examples that follow represent techniques discovered by the inventors to function well in the practice of the invention. However, those of skill in the art should, in light of the present disclosure, appreciate that many changes can be made in the specific embodiments that are disclosed and still obtain a like or similar result without departing from the scope of the invention.

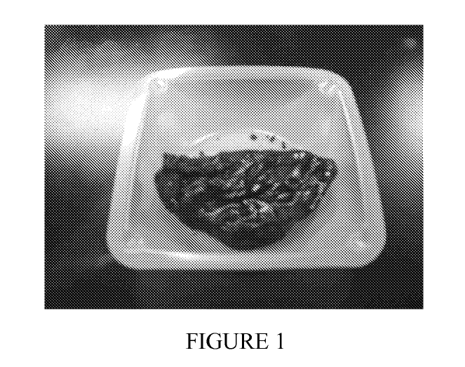

The sample of naphthenic scale used for the examples was a shiny black, oily solid with a consistency of rock candy, as shown in FIG. 1. Various types of fluid dissolver systems were used with the scale material at a test temperature of 120° F. to determine the best formulation mixture to dissolve the scale material. After determining the best formulation for dissolving the scale material, corrosion studies were conducted with the formulation to determine the corrosion rate on N80 carbon steel and QT800 coiled tubing.

Table 1 summarizes the results of the tests with various different fluid systems, some of which were made in accordance with embodiments of the present invention. Based on the test results, the best treatment fluid for dissolving the scale sample was a blend of glacial acetic acid and xylene, which is in accordance with an embodiment of the present invention. A mixture of 50 wt. % glacial acetic acid/50 wt. % xylene dissolved a sample of the scale in 1 hour at a test temperature of 120° F. A blend of 75 wt. % glacial acetic acid/25 wt. % xylene dissolved a sample of the scale in two hours at a test temperature of 120° F. Review of the other test data in the Table 1 shows that glacial acetic acid alone or xylene alone took much longer to dissolve the scale sample at 120° F.

Review of the other test data shows that another test system (75 wt. % glacial acetic acid/25 wt. % environmentally degradable solvent system) also worked well in dissolving the scale within one hour at 120° F. This fluid mixture is composed of 75 wt. % glacial acetic acid with 25 wt. % of a environmentally friendly totally biodegradable (ethyl lactate/methyl ester) solvent system. Testing of this system was conducted to provide a more environmentally friendly solvent system option, as an aspect of the present invention. This environmentally friendly solvent system is totally biodegradable into carbon dioxide and water.

It is recommended that a small spacer of diesel or xylene be pumped ahead of the main treatment to displace any water present on the scale to obtain the best dissolution results.

TABLE 1

| | |
|---|---|
| | Dissolution Rate |
| Fluid Composition | AT 120° F. |

Successful Dissolution Fluid Systems

| | |
|---|---|
| 50% Glacial Acetic Acid/50% Xylene | Scale dissolved in 1 hour |
| 75% Glacial Acetic Acid/25% Xylene | Scale dissolved in 2 hours |
| 75% Glacial Acetic Acid/ | Scale dissolved in 1 hour. |
| 25% Biodegradable Environmentally | |
| Friendly (ethyl lactate/methyl ester) | |
| solvent | |
| 60% Glacial Acetic Acid, 30% xylene, 10% | Scale dissolved in 3 hours |
| US 40 | |
| 75% Glacial Acetic Acid, 25% Paravan-25 | Scale dissolved in 2 hours |
| 50% Glacial Acetic Acid, 30% xylene, 20% | Scale dissolved in 3 hours |
| US40 | |

Unsuccessful Dissolution Fluid Systems

| | |
|---|---|
| 100% Glacial Acetic Acid | Scale dissolved |
| | in 5 hours. |
| 15% HCl acid | Scale did not dissolve |
| | in 24 hours |
| Paravan-25 | Scale did not dissolve in |
| | 24 hours |
| Xylene | Scale did not dissolve |
| | in 24 hours |
| Environmental biodegradable solvent | Scale did not dissolve |
| | in 24 hours |
| Exxon Exxate 700 | Scale did not dissolve |
| | in 24 hours |
| Diesel | Scale did not dissolve |
| | in 24 hours |
| Dissolvine H40 (Trisodium HEDTA) | Scale did not dissolve |
| | in 24 hours |
| EMIM CL Ionic Liquid | Scale did not dissolve |
| | in 24 hours |
| HV Acid | Scale did not dissolve |
| | in 24 hours |
| MTBS Ionic liquid | Scale did not dissolve |
| | in 24 hours |
| AM40 (Diammonium EDTA) | Scale did not dissolve |
| | in 24 hours |
| 15% Acetic acid/10% xylene/75% water | Scale did not dissolve |
| | in 24 hours |
| 25% Acetic acid/15% xylene/60% water | Scale did not dissolve |
| | in 24 hours |
| 50% Acetic acid/25% xylene/25% water | Scale dissolved in 21 hours |

HEDTA = hydroxy ethylene diamine triacetic acid
EMIM = ethyl methyl imidazolium
HV = organophosphonate
MTBS = methyltributylammonium sulfate
EDTA = ethylene diamine tetra acetic acid

The scale material was also submitted to an analytical lab for elemental and composition determination. An organic analysis of the scale was performed on a carbon, hydrogen, nitrogen, sulfur (CHNS) analyzer to determine the total nitrogen, hydrogen, carbon and sulfur composition. An inductively coupled plasma (ICP) analysis was also conducted on an acid digested sample to obtain the elemental concentrations of calcium, magnesium, sodium, and iron. Table 2 details the results of the CHNS analysis and the elemental ICP analysis on the submitted scale sample. The analysis showed that the sample was composed of calcium with smaller concentrations of sodium and iron. The CHNS analysis showed a composition of 65.5 wt. % carbon, 9.0 wt. % hydrogen, 2.0 wt. % nitrogen and 0 wt. % sulphur.

TABLE 2

| Element | Composition (wt. %) |
|---|---|
| Carbon | 65% |
| Nitrogen | 2.0% |
| Hydrogen | 9.0% |
| Sulfur | 0% |
| Calcium | 2.78% |
| Sodium | 0.55% |
| Iron | 0.39% |

As indicated previously, corrosion studies were performed on some of the compositions that were used for the scale dissolving example to determine the corrosion rate of the dissolvers. Two compositions were used to conduct the corrosion studies. The first composition comprised 50 wt. % glacial acetic acid/50 wt. % xylene and the second composition comprised 75 wt. % glacial acetic acid/25 wt. % xylene. The tests were conducted at a test temperature of 160° F. with an exposure period of five hours at atmospheric pressure in a pre-heated water bath. The corrosion studies were conducted with both N80 carbon steel and QT800 coiled tubing metals. It has been reported that the treatment fluid may be pumped through coiled tubing. A set of corrosion studies with the 50 wt. % glacial acetic acid/50 wt. % xylene mixtures were conducted by diluting the acid formulation with 50 wt. % water to simulate the treatment fluid mixing with any water present in the wellbore. These tests were conducted to check for the breakout of the xylene possibly pulling the corrosion inhibitor out of the acid portion and resulting in increased corrosion rates of the test metals.

Table 3 of this report details the results of the corrosion studies conducted with the acid fluid 1 (75 wt. % glacial acetic acid/25 wt. % xylene) and the acid fluid 2 (50 wt. % glacial acetic acid/50 wt. % xylene) mixtures with metal # 1 (carbon steel N80) and metal # 2 (QT800) metals at 160° F. at atmospheric pressure for a five hour exposure period. Results of the corrosion studies with both formulations show the corrosion rate will meet the generally accepted industry requirement of less than <0.02 lbs/ft²/time period for the coiled tubing QT800 and less than <0.05 lbs/ft²/time period for the N80 coupons during the five hour incubation at 160° F. with the addition of 10 gpt of CI-11 or 10 gpt CI-27. The corrosion rate studies with the addition of the acid fluid 3 (water added to the acid fluid 2 in a 50% by volume ratio) were also within corrosion rate specifications with the CI-11 and CI-27 corrosion inhibitor additions. Water was added to simulate acid and water mixing in a wellbore.

TABLE 3
Corrosion Studies With Recommended
Glacial Acetic/Xylene Treatment Fluid

| | | | Concentration | Corrosion Rate | Pitting |
|---|---|---|---|---|---|
| Acid # | Metal # | Inhibitor | (gpt) | (lbs/ft²/time) | Rating |
| 1 | 1 | CI-11 | 10 | 0.0059 | 1 |
| 1 | 1 | CI-11 | 15 | 0.0065 | 2 |
| 1 | 1 | CI-11 | 20 | 0.0052 | 1 |
| 1 | 1 | CI-11 | 25 | 0.0045 | 0-1 |
| 1 | 1 | CI-11 | 30 | 0.0057 | 1 |
| 1 | 2 | CI-11 | 10 | 0.0043 | 1 |
| 1 | 2 | CI-11 | 15 | 0.0039 | 1 |
| 1 | 2 | CI-11 | 20 | 0.0052 | 0 |
| 1 | 2 | CI-11 | 25 | 0.0034 | 0 |
| 1 | 2 | CI-11 | 30 | 0.0048 | 0 |
| 2 | 1 | CI-11 | 10 | 0.0039 | 1 |
| 2 | 1 | CI-27 | 10 | 0.0068 | 1 |
| 3 | 1 | CI-11 | 10 | 0.0024 | 1 |
| 3 | 1 | CI-27 | 10 | 0.0176 | 1 |
| 2 | 2 | CI-11 | 10 | 0.0036 | 0 |
| 2 | 2 | CI-27 | 10 | 0.0054 | 0 |
| 3 | 2 | CI-11 | 10 | 0.0015 | 1 |
| 3 | 2 | CI-27 | 10 | 0.0141 | 0-1 |

The pitting was evaluated using the following pitting scale, which was used for all of the examples described herein:

0 = no pitting, staining or surface irregularities;
0-trace = slight staining of surface, but no surface irregularities;
trace = a trace amount of pitting on surface;
1 = slightly more than a trace amount of pitting on surface;
2 = a small amount of pitting on the surface;
3 = a medium amount of pitting on the surface;
4 = a large amount of pitting on the surface; and
5 = large holes or very deep pits anywhere on the test coupon.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations can be applied to the compositions and/or methods and in the steps or in the sequence of steps of the methods described herein without departing from the concept, spirit and scope of the invention. More specifically, it will be apparent that certain agents that are chemically related can be substituted for the agents described herein while the same or similar results would be achieved. All such similar substitutes and modifications apparent to those skilled in the art are deemed to be within the scope and concept of the invention.

What is claimed is:

1. A method of dissolving naphthenic acid solids in equipment comprising the steps of:
a. contacting a naphthenic acid solid with a treatment fluid comprising:
i. glacial acetic acid; and
ii. a solvent in which the glacial acetic acid is soluble or a solvent that is soluble in the glacial acetic acid;
b. dissolving at least a portion of the naphthenic acid solid.

2. The method of claim 1, wherein the glacial acetic acid is present in a range of about 25 wt. % to about 75 wt. % and the solvent is present in a range of about 25 wt. % to about 75 wt. %.

3. The method of claim 1, wherein the solvent comprises xylene, an ethyl lactate/methyl ester solvent, hexane, heptane, naphtha, kerosene, benzene, toluene, styrene, tetrahydroanaphthalene, decahydroanaphthalene, carbon tetrachloride, acetone, carbon disulfide, n-pentane, terpene, or combinations thereof.

4. The method of claim 3, wherein the solvent comprises the ethyl lactate/methyl ester solvent, wherein ethyl lactate is present in a range of about 40 wt. % to about 60 wt. % and methyl ester is present in a range of about 40 wt. % to about 60 wt. %.

5. The method of claim 1, wherein the naphthenic acid solids comprise magnesium, calcium, sodium, carbonate, bicarbonate, chloride, sulfate, strontium, or combinations thereof.

6. The method of claim 1, wherein the equipment comprises tubing, pipelines, surface equipment, downhole tubulars, perforations, formation lines or pipes, flow lines or pipes, or combinations thereof.

7. The method of claim 1 wherein the step of contacting the naphthenic acid solid with the treatment fluid occurs in the presence of water.

8. A method of treating equipment comprising introducing into the equipment a treatment fluid comprising:
a. glacial acetic acid; and
b. a solvent in which the glacial acetic acid is soluble or a solvent that is soluble in the glacial acetic acid;
the treatment fluid being capable of dissolving at least a portion of a naphthenic acid solid contained within the equipment.

9. The method of claim 8, wherein the glacial acetic acid is present in a range of about 25 wt. % to about 75 wt. % and the solvent is present in a range of about 25 wt. % to about 75 wt. %.

10. The method of claim 8, wherein the solvent comprises xylene, an ethyl lactate/methyl ester solvent, hexane, heptane, naphtha, kerosene, benzene, toluene, styrene, tetrahydroanaphthalene, decahydroanaphthalene, carbon tetrachloride, acetone, carbon disulfide, n-pentane, terpene, or combinations thereof.

11. The method of claim 10, wherein the solvent comprises the ethyl lactate/methyl ester solvent, wherein ethyl lactate is present in a range of about 40 wt. % to about 60 wt. % and methyl ester is present in a range of about 40 wt. % to about 60 wt. %.

12. The method of claim 8, wherein the naphthenic acid solids comprise magnesium, calcium, sodium, carbonate, bicarbonate, chloride, sulfate, strontium, or combinations thereof.

13. The method of claim 8, wherein the step of contacting the naphthenic acid solid with the treatment fluid occurs in the presence of water.

14. A naphthenic acid solids dissolver composition comprising:
a. glacial acetic acid; and
b. a solvent in which the glacial acetic acid is soluble.

15. The treatment fluid of claim 14, wherein the glacial acetic acid is present in a range of about 25 wt. % to about 75 wt. % and the solvent is present in a range of about 25 wt. % to about 75 wt. %.

16. The treatment fluid of claim 14, wherein the solvent comprises xylene, an ethyl lactate/methyl ester solvent, hexane, heptane, naphtha, kerosene, benzene, toluene, styrene, tetrahydroanaphthalene, decahydroanaphthalene, carbon tetrachloride, acetone, carbon disulfide, n-pentane, terpene, or combinations thereof.

17. The treatment fluid of claim 16, wherein the solvent comprises the ethyl lactate/methyl ester solvent, wherein ethyl lactate is present in a range of about 40 wt. % to about 60 wt. % and methyl ester is present in a range of about 40 wt. % to about 60 wt. %.

18. The treatment fluid of claim 14, wherein the naphthenic acid solids comprise magnesium, calcium, sodium, carbonate, bicarbonate, chloride, sulfate, strontium, and various other compounds or combinations thereof.

19. The treatment fluid of claim 11, wherein the equipment comprises tubulars, surface equipment, downhole tubulars, perforations, formation lines or pipes, flow lines or pipes, or combinations thereof.

20. The treatment fluid of claim 19, wherein the treatment fluid further comprises water.

21. A naphthenic acid solids dissolver composition comprising:
a. glacial acetic acid; and
b. a solvent that is soluble in the glacial acetic acid.
